(19) United States
(12) Patent Application Publication
(10) Pub. No.: US 2004/0213273 A1
(43) Pub. Date: Oct. 28, 2004

(54) Network attached storage device servicing audiovisual content

(76) Inventor: Kenneth Ma, Cupertino, CA (US)

Correspondence Address: James A. Harrison, Garlick Harrison & Markison, LLP, P.O. Box 670007, Dallas, TX, 75367, US

(21) Appl. No.: 10/829,498

(22) Filed: Apr. 22, 2004

Related U.S. Application Data
(60) Provisional application No. 60/464,583, filed on Apr. 22, 2003.

(51) Int. Cl. H04L 12/66

(52) U.S. Cl. 370/401

(57) ABSTRACT

A system for wireless and wired servicing of audiovisual and data networking communications includes a gateway that services communications within a network to provide expected quality playback in view of a plurality of media characteristics in a manner that further includes copy protection control. The network attached storage device (NAS) evaluates a content creation source, a transmission media, end device playback technology and media type, a hierarchy of content creation sources, a hierarchy of transmission media, and a hierarchy of end device playback technology along with specified quality of service requirements as a part of determining allocated bandwidth and transmission priority and to define a hierarchy of content creation sources including professionally recorded and distributed materials, specified media resolution characteristics, downloaded materials, and personal recording through a home recording device. The NAS further includes OTP-PKI protection schemes but further evaluates end device capabilities when producing digital audiovisual programming.

### CROSS REFERENCE TO RELATED APPLICATIONS

This application claims priority to U.S. Provisional Patent Application Serial No. 60/464,583, filed Apr. 22, 2003, which is incorporated herein by reference for all purposes.

### BACKGROUND

1. Technical Field

This invention relates generally to the service of audiovisual content within a wireless network.

2. Related Art

Communication technologies that link electronic devices in a networked fashion are well known. Examples of communication networks include wired packet data networks, wireless packet data networks, wired telephone networks, wireless telephone networks, and satellite communication networks, among other networks. These communication networks typically include a network infrastructure that services a plurality of client devices. The Public Switched Telephone Network (PSTN) is probably the best known communication network that has been in existence for many years. The Internet is another well-known example of a communication network that has also been in existence for a number of years. These communication networks enable client devices to communicate with one another on a global basis. Wired Local Area Networks (wired LANs), e.g., Ethernets, are also quite common and support communications between networked computers and other devices within a serviced area. Wired LANs also often link serviced devices to Wide Area Networks and the Internet. Each of these networks is generally considered a “wired” network, even though some of these networks, e.g., the PSTN, may include some transmission paths that are serviced by wireless links.

Wireless networks have been in existence for a relatively shorter period. Cellular telephone networks, wireless LANs (WLANs), and satellite communication networks, among others, are examples of wireless networks. Relatively common forms of WLANs are IEEE 802.11(a) networks, IEEE 802.11(b) networks, and IEEE 802.11(g) networks, referred to jointly as “IEEE 802.11 networks.” In a typical IEEE 802.11 network, a wired backbone couples to a plurality of Wireless Access Points (WAPs), each of which supports wireless communications with computers and other wireless terminals that include compatible wireless interfaces within a serviced area. The wired backbone couples the WAPs of the IEEE 802.11 network to other networks, both wired and wireless, and allows serviced wireless terminals to communicate with devices external to the IEEE 802.11 network. IEEE 802.11 networks now commonly support enterprises, offices, and homes. In particular, the IEEE 802.11 networks typically service data sharing, connectivity requirements, and network access requirements for a serviced network of computers.

Networks that consolidate and distribute audiovisual information are also well known. Satellite and cable-based communication networks broadcast a significant amount of audio and audiovisual content. Further, these networks also may be constructed to provide programming on demand, e.g., video-on-demand. In these environments a signal is broadcast, multicast, or unicast via a servicing network, and a Set-Top-Box (STB) local to a delivery point receives, demodulates, and decodes the signal and places the audiovisual content into an appropriate format for playing on a delivery device, e.g., monitor and audio system. Recording of the audiovisual information for later playback has been recently introduced as an option for STBs. In such case, the STBs include a hard drive that stores encoded audiovisual information for later playback. This type of system is referred to as a Personal Video Recorder (PVR).

However, as the volume required for storage per program increases, for example with high definition television (HDTV) programs, smaller and less expensive hard drives can no longer be used. Thus, the user must store fewer programs. Further, when a user wants to upgrade his or her STB to a PVR, a servicing company must be deployed to either install a hard drive into the STB or to swap the non-PVR STB with a PVR STB.

### SUMMARY OF THE INVENTION

A system for wireless and wired servicing of audiovisual and data networking communications includes a gateway that services communications within a network to provide expected quality playback in view of a plurality of media characteristics in a manner that further includes copy protection control, wherein the communications are produced ultimately to at least one user playback end device communicatively coupled to the network gateway. The system more specifically includes a content and transmission media aware network attached storage device (NAS) wherein the NAS services communications through the gateway to the end device in the network from content stored in the NAS at a data rate sufficient to enable real time playback of audiovisual programming at an expected quality level. The NAS, in servicing communications between the gateway and the NAS, generates the communications at a data rate sufficient to enable real time playback of audiovisual programming stored on the NAS employing bandwidth allocation operations so that sufficient data throughput is provided to the communications.

The NAS determines end-to-end quality of service for playback of the audiovisual programming stored on the NAS by evaluating a content creation source, a transmission media, end device playback technology, and media type. More specifically, the NAS is operable to evaluate a hierarchy of content creation sources, a hierarchy of transmission media, and a hierarchy of end device playback technology along with specified quality of service requirements as a part of determining allocated bandwidth and transmission priority and to define a hierarchy of content creation sources, including professionally recorded and distributed materials, specified media resolution characteristics, downloaded materials, and personal recording through a home recording device. Defining a hierarchy of transmission media includes determining network type, including determining whether the transmission media includes data packet networks, instructure dedicated wired coupling, wireless communication links and further defining an associated bandwidth for each. Defining a hierarchy of end device playback technology includes determining whether a device type is a standard display television, high definition television, portable digital video recorder, personal computer monitor, wired high fidelity sound system, wireless headphones, wired headphones and handheld display devices. In one embodiment of the invention, the NAS is operable to provide port based bandwidth priority wherein a device transmitting digital media on a first port is given priority over a device transmitting digital media on a second port. With respect to the playback technology, the NAS further evaluates associated display resolution parameters.

The NAS further provides a plurality of approaches for protection of audiovisual programming including being operable to evaluate digital rights management parameters to determine whether a public key infrastructure (PKI) code is enabling and whether the end device is an authorized device for the PKI code. Additionally, the NAS evaluates destination usage rules and capability of the end device as well as copy protection capabilities of the end device as a part of determining whether to produce audiovisual programming to the end device as well as signal quality. For example, the NAS only produces audiovisual programming having copy restrictions to a PKI enabled device that does not have copying capability for making permanent copies of the audiovisual programming in one embodiment of the invention. The NAS is further operable to store the audiovisual programming in a proprietary and non-standard format to preclude unauthorized access wherein the proprietary and non-standard format is not decipherable by known devices that read digital media.

### BRIEF DESCRIPTION OF THE DRAWINGS

These and other features, aspects and advantages of the present invention will be more fully understood when considered with respect to the following detailed description, appended claims and accompanying drawings wherein:

FIG. 1 is a functional block diagram illustrating a communication system that includes a plurality of base stations or access points, a plurality of wireless communication devices, and a network hardware component;

FIG. 2 is a schematic block diagram illustrating a wireless communication device as a host device and an associated radio;

FIG. 3 is a system diagram illustrating a wireless network storage solution constructed according to the present invention;

FIG. 4A is a block diagram illustrating a Network Attached Storage (NAS) device constructed according to the present invention;

FIG. 4B is a functional block diagram of a two-part digital recording and playback system formed according to one embodiment of the invention;

FIG. 5 is a block diagram illustrating the structure of a NAS constructed according to the present invention;

FIG. 6 is a functional block diagram of a NAS formed according to one embodiment of the invention;

FIG. 7 is a method for transmitting audiovisual programming according to one embodiment of the present invention; and

FIG. 8 is a flowchart illustrating a method for processing audiovisual programming according to one embodiment of the present invention.

### DETAILED DESCRIPTION OF THE DRAWINGS

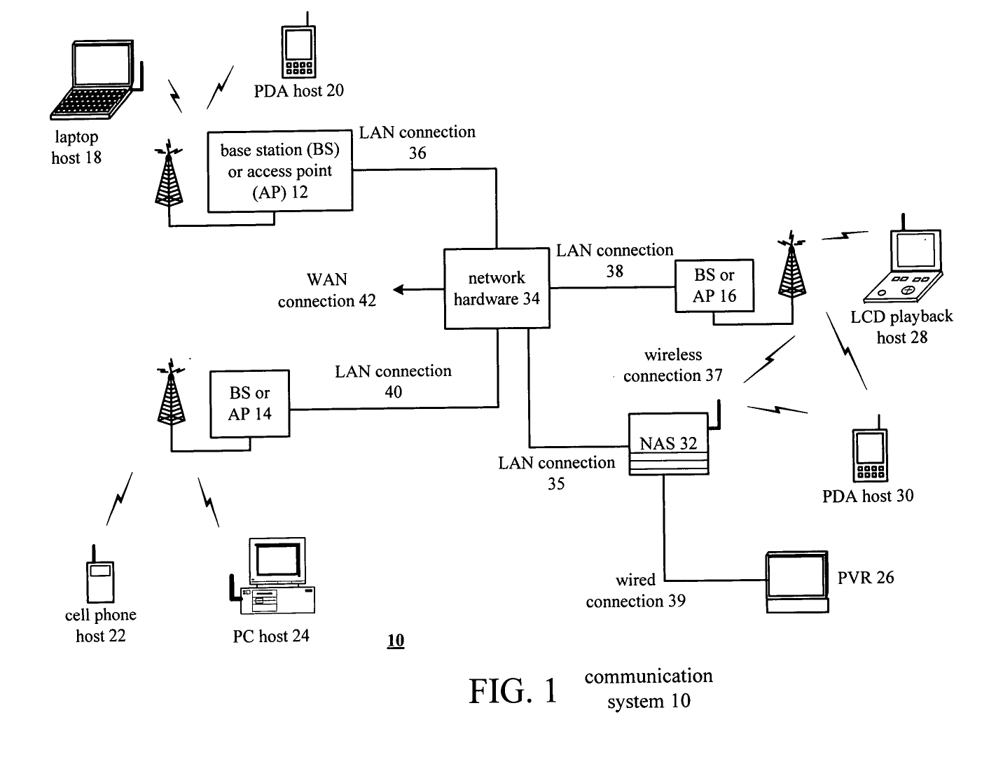

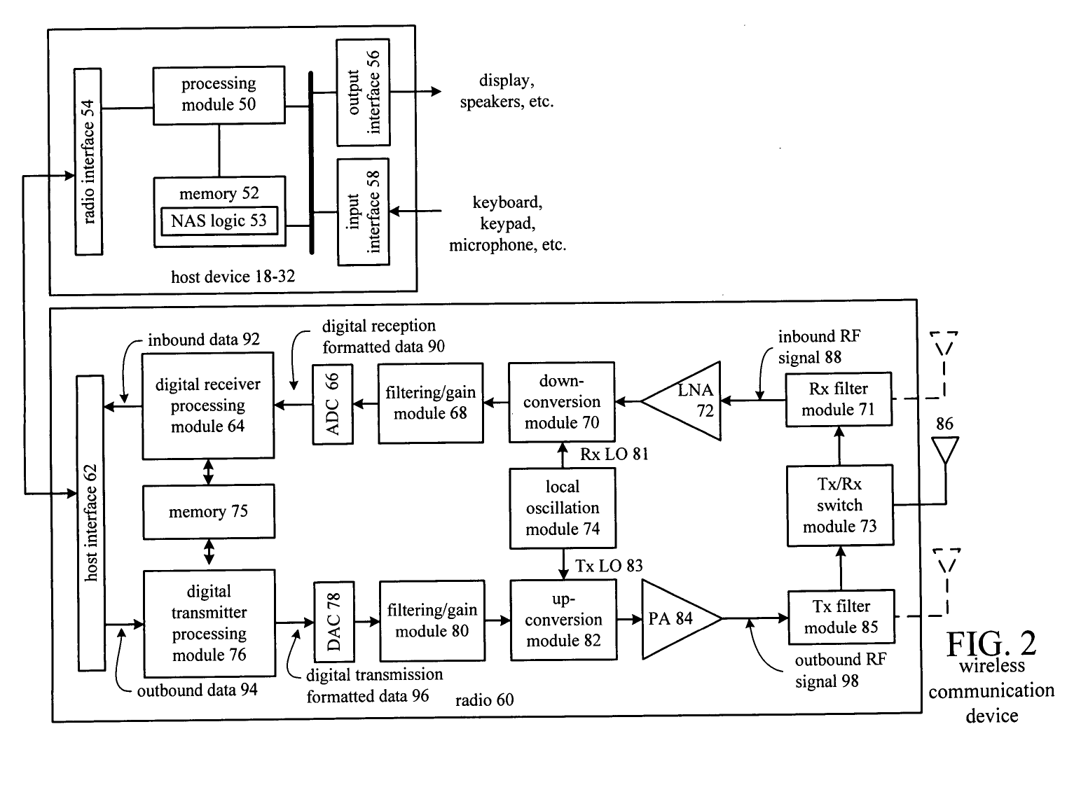

FIG. 1 is a functional block diagram illustrating a communication system 10 that includes a plurality of base stations or access points (AP) 12-16, a plurality of wireless communication devices 18-30, a network attached storage (NAS) device 32, and a network hardware component 34. The wireless communication devices 18-30 may be laptop host computers 18, personal digital assistant hosts 20 and 30, personal computer hosts 24 and/or cellular telephone hosts 22. The details of the wireless communication devices will be described in greater detail with reference to FIG. 2. The base stations or access points 12-16 are operably coupled to the network hardware component 34 via local area network (LAN) connections 36, 38 and 40. Additionally, network hardware component 34, which may be a router, switch, bridge, modem, system controller, etc., provides a wide area network (WAN) connection 42 for the communication system 10. Each of the base stations or access points 12-16, as well as NAS 32, has an associated antenna or antenna array to communicate with the wireless communication devices in its area in the described embodiment of the invention. NAS 32, in the described embodiment, is further operable to communicate with base stations or access points 12-16 by way of at least one LAN connection for generating wireless communications to communication devices 18-30. Typically, the wireless communication devices 18-30 register with the particular base stations or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio. As may be seen, a base station/access point 12 may communicate over an RF channel with either host 18 or 20. Base station/access point 12 is further coupled to network hardware component 34 that is further coupled to other base stations/access points 14 and 16. Each connection between network hardware 34 and the base station/access points is by way of a LAN connection 36, 38 or 40, respectively. Further, network hardware component 34 is connected to NAS 32 by way of a LAN connection 35. NAS 32 is communicatively coupled by wired as well as wireless communication links for operation according to the various aspects of the present invention as disclosed herein. Accordingly, NAS 32 produces stored digital data including audiovisual programming to any destination device by way of a corresponding base station/access point 12-16 or directly by a wired connections such as wired connection 39. Additionally, NAS 32 may produce such digital data directly over a wireless medium to a wireless communication device such as PDA host 30 or LCD playback host 28 (both of which may also receive the same communications from base station or access point 16 according to system configuration. To transmit such data over a wireless medium, NAS 32 includes transceiver circuitry in one embodiment (as illustrated in the embodiment of FIG. 2, below). In an alternate embodiment, NAS 32 is coupled to a wireless transceiver. Thus, NAS 32 is operable to deliver digital data including audiovisual programming to a personal video recorder (PVR) 26 directly by wired connection 39, by way of base station/access point 16 and network hardware component 34, or directly from NAS 32 by way of a wireless communication channel.

FIG. 2 is a schematic block diagram illustrating a NAS 32 with an associated radio 60. For cellular telephone hosts, the radio 60 is a built-in component. For personal digital assistants hosts, laptop hosts, and/or personal computer hosts, the radio 60 may be built-in or an externally coupled component.

As illustrated, NAS 32 includes a processing module 50, a memory 52, a radio interface 54, an input interface 58 and an output interface 56. Memory 52 includes, in the described embodiment, computer instructions that define NAS logic for operation according to the described embodiments herein as shown in FIG. 2 as NAS logic 53. The logic defined within NAS logic block 53 may also be implemented in any other known form including programmable logic and fixed logic. The processing module 50 and memory 52, in the described embodiment, execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an IF mixing up-conversion module 82, a power amplifier 84, a transmitter filter module 85, and an antenna 86. The antenna 86 is shared by the transmit and receive paths as regulated by the Tx/Rx switch module 73. The antenna implementation will depend on the particular standard to which the wireless communication device is compliant.

The digital receiver processing module 64 and the digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and/or modulation. The digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the digital receiver processing module 64 and/or the digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory 75 stores, and the digital receiver processing module 64 and/or the digital transmitter processing module 76 executes, operational instructions corresponding to at least some of the functions illustrated herein.

In operation, the radio 60 receives outbound data 94 from the host wireless communication device 18-32 via the host interface 62. The host interface 62 routes the outbound data 94 to the digital transmitter processing module 76, which processes the outbound data 94 in accordance with a particular wireless communication standard (e.g., IEEE 802.11a, IEEE 802.11b, Bluetooth, etc.) to produce digital transmission formatted data 96. The digital transmission formatted data 96 will be a digital baseband signal or a digital low IF signal, where the low IF typically will be in the frequency range of one hundred kilohertz to a few megahertz.

The digital-to-analog converter 78 converts the digital transmission formatted data 96 from the digital domain to the analog domain. The filtering/gain module 80 filters and/or adjusts the gain of the analog baseband signal prior to providing it to the up-conversion module 82. The up-conversion module 82 directly converts the analog baseband signal, or low IF signal, into an RF signal based on a transmitter local oscillation 83 provided by local oscillation module 74. The power amplifier 84 amplifies the RF signal to produce an outbound RF signal 98, which is filtered by the transmitter filter module 85. The antenna 86 transmits the outbound RF signal 98 to a targeted device such as a base station, an access point and/or another wireless communication device.

The radio 60 also receives an inbound RF signal 88 via the antenna 86, which was transmitted by a base station, an access point, or another wireless communication device. The antenna 86 provides the inbound RF signal 88 to the receiver filter module 71 via the Tx/Rx switch module 73, where the Rx filter module 71 bandpass filters the inbound RF signal 88. The Rx filter module 71 provides the filtered RF signal to low noise amplifier 72, which amplifies the inbound RF signal 88 to produce an amplified inbound RF signal. The low noise amplifier 72 provides the amplified inbound RF signal to the down-conversion module 70, which directly converts the amplified inbound RF signal into an inbound low IF signal or baseband signal based on a receiver local oscillation signal 81 provided by local oscillation module 74. The down-conversion module 70 provides the inbound low IF signal or baseband signal to the filtering/gain module 68. The filtering/gain module 68 may be implemented in accordance with the teachings of the present invention to filter and/or attenuate the inbound low IF signal or the inbound baseband signal to produce a filtered inbound signal.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92 in accordance with the particular wireless communication standard being implemented by radio 60. The host interface 62 provides the recaptured inbound data 92 to the host wireless communication device 18-32 via the radio interface 54.

As one of average skill in the art will appreciate, the wireless NAS of FIG. 2 may be implemented using one or more integrated circuits. For example, the host device may be implemented on a first integrated circuit, while the digital receiver processing module 64, the digital transmitter processing module 76 and memory 75 are implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device and the digital receiver processing module 64 and the digital transmitter processing module 76 may be a common processing device implemented on a single integrated circuit. Further, memory 52 and memory 75 may be implemented on a single integrated circuit and/or on the same integrated circuit as the common processing modules of processing module 50, the digital receiver processing module 64, and the digital transmitter processing module 76.

FIGS. 1 and 2 illustrate but one embodiment of the present invention and a network within which the present and described embodiments apply. Generally, radio transceiver technology formed and used as described in FIGS. 1 and 2 may be included in any embodiment of the invention. For example, a NAS may be coupled to communicate with a radio such as that shown in FIG. 2 within a network as shown in FIG. 1. NAS 32 is not limited to wireless operation and is shown as a wireless device in FIG. 2 for exemplary purposes.

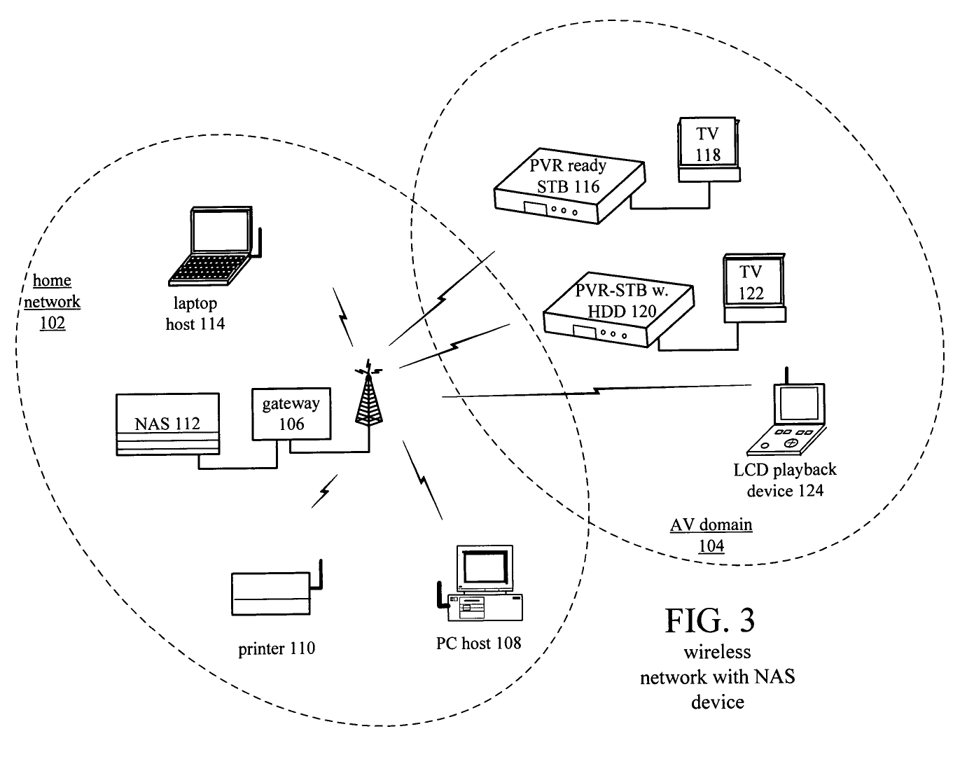

FIG. 3 is a system diagram illustrating a wireless network storage solution constructed according to the present invention. As illustrated, a home network 102 and a wireless audio/video (AV) domain 104 include a plurality of wireless receivers and transceivers that perform specified functions. More specifically, home network 102 includes a wireless gateway 106 that services a PC host 108, a printer 110, a Network Attached Storage device (NAS) 112, and a laptop host 114. The wireless gateway 106 also services the communication requirements of AV domain 104 that includes a Personal Video Recorder (PVR) ready Set-Top-Box (STB) 116, which services a television 118, a PVR-STB 120 that services a television 122, and an LCD playback device 124. PVR-STB 120 includes at least one hard disk drive (HDD) for storing audiovisual programming for playback on a display device which, in the described embodiment, is TV 122. LCD playback device 124 may comprise any one of a plurality of forms including an in-car LCD playback device. For such an embodiment, gateway 106 wirelessly uploads audiovisual programming to LCD playback device 124 prior to the vehicle departing to enable passengers to be entertained by the audiovisual programming. All of this assumes, however, that specified requirements for authorization, as described in greater detail below, are satisfied. Moreover, as NAS 112 produces digital data, including audiovisual programming to the various types of devices such as laptop host 114, printer 110, PC host 108, PVRs 116 and 120, and LCD playback device 124 (these devices are listed for exemplary purposes and are not intended to be limiting), NAS 112 evaluates overall communication capacity of any one transmission media or network element in determining priority and associated throughput. For example, continuous bit rate data (streaming video or audio) to be played on LCD playback device 124 without storage is given higher priority than audiovisual programming that is merely being uploaded and stored for playback at a later time. Moreover, such data is further given priority over data files being produced to laptop host 114, PC host 108 or printer 110.

The wireless gateway 106 supports a high data rate networking protocol, e.g., IEEE 802.11(a), IEEE 802.11(g), etc., that provides sufficient data rates to service the communication requirements of each serviced device. In particular, the wireless gateway 106 provides sufficient data rates between the PVR ready STB 116, the PVR-STB 120, the LCD playback device 124, and the NAS 112 to enable real-time playback of programming stored on the NAS 112. In an example of an operation of the present invention, either PVR ready STB 116 or PVR-STB 120 receives programming from its servicing network, e.g., cable network, satellite network, fixed wireless network, etc. and converts the received programming into a format suitable for storage. The NAS 112 receives and stores the programming PVR ready STB 116 or PVR-STB 120 and stores the programming via the wireless gateway 106. These operations need not occur in real-time because this is not a time sensitive path. In one embodiment of the present invention, the wireless gateway 106 will employ Quality of Service (QoS) operations and/or bandwidth allocation operations sufficient to service these storage operations in real-time. In a playback operation, the wireless gateway 106 and the NAS 112 must read and transfer the stored programming at a sufficient data rate to the PVR ready STB 116, the PVR-STB 120, or the LCD playback device 124 for playback. Thus, QoS and/or bandwidth provisioning operations according to the present invention are supported so that the stored programming will be played back in real-time by the PVR ready STB 116 or PVR-STB 120.

According to one aspect of the present invention, a priority-based QoS scheme may be employed. With this scheme, programming has prioritized media access and packet tagging may be employed such that the programming will have priority in transmission with the home network 102 (as serviced by the wireless gateway 106). In particular, up to eight priority levels may be employed to guarantee that the wireless network provides sufficient data throughput to service all the ongoing audiovisual program transactions that exist. This priority scheme may provide priorities by file/stream types or destination ID, e.g., PVR ready STB 116 or PVR-STB 120.

Alternately, a priority scheme may be used that provides the following priorities: (1) PVR files; (2) MPG, AVI, WMV files; (3) MP3, WMA, AAC files; and (4) bulk data files. The file system is set up in the NAS 112 and managed/enforced by the wireless gateway 106 in one embodiment. Alternately, the QoS may be session based, setup by the NAS, and managed/enforced by the wireless gateway 106. In such case, the enforcing device ensures specific sessions are guaranteed service levels.

According to another aspect of the present invention, the wireless gateway 106 performs bandwidth provisioning operations to ensure that the PVR ready STB 116, the PVR-STB 120, the LCD playback device 124, and the NAS 112 receive specified priority for communications. In such case, the wireless gateway 106 performs bandwidth provisioning of its ports, i.e., Ethernet ports and the wireless network interface, to these devices. In an alternate construction, the NAS 112 couples via a wired link to the wireless gateway 106 and the wireless gateway 106 provisions the wired link bandwidth between the transactions of its serviced devices. In one particular operation of the present invention, QoS by bandwidth is performed such that a maximum required bandwidth is determined and a 4× headroom bandwidth allocation scheme is implemented by the wireless gateway 106. A gigabit Ethernet link between the NAS 112 and the wireless gateway 106, if present, is allocated with the same headroom requirements.

According to another aspect of the present invention, the system operates to protect media rights. Typically, laws and contracts governing the distribution and performance of audiovisual programming allow a user to privately view a purchased program as many times as desired, some time for a limited time span. Likewise, laws and contracts typically allow a purchaser of a CD, a DVD, or a video game to make a backup copy of the content. However, it is generally illegal to use/view both the primary copy and the backup copy simultaneously.

Thus, the system of the present invention operates to protect these media rights in a manner to goes beyond known digital rights management schemes. In particular, the system of the present invention assumes the source content has enough protection mechanism against unauthorized copy. It further assumes the system of present invention provides a “software player” to enable legitimate ripping (copying) of the content into the NAS 112 with a special tag, format and metadata. Once ripped into the NAS 112, the NAS 112 enforces a set of rules that govern the playback or reading of the ripped contents:

a. the stored files are NOT visible by other applications except by a legitimate software player (which can be different from the one that rips into NAS 112). In one embodiment of the invention, the NAS utilizes a proprietary formatting system to preclude reading of the stored materials even if a security system protected, for example by password, is thwarted or alternatively, to preclude reading by other devices if there is no protection.

b. the files can be streamed (played) across the home network 102 with the legitimate software player on PC host 108, laptop host 114, PVR ready STB 116 or PVR-STB 120 (for playback on TVs 118 and 122 in the described embodiment), or a digital media adapter, etc., for playback on a device coupled thereto (enforced by NAS 112, perhaps with the assistance of the wireless gateway 106). The files or media may be streamed by wireless or wired communication links.

c. the same file cannot be played by more than one device at any time to comply with Copyright Law (enforced by NAS 112). If the NAS produces the materials to a device that only has capacity for real time playback (no storage capacity), the NAS will only produce to one device at a time. If the device has capacity for storage, the NAS will not produce a subsequent copy to any other playback device until such time that the NAS determines that the previously produced copy has been, removed, deleted, or destroyed. For example, if the media is produced with a time based self destruction mechanism, the NAS will not produce additional copies until that time value has expired. Alternatively, the NAS will produce an additional playback copy once a specified indication is received indicating that the previously produced copy has been, removed, deleted, or destroyed.

d. the files may not be copied to another device unless the copy on the NAS has been deleted first. If a request is made to produce the media to a device for permanent copying, the NAS will not produce it with destroying the media or files stored on the NAS. Moreover, in one embodiment, the NAS will not produce the media or files to another device unless the receiving device also has capacity to regulate usage that at least comport with known digital rights management rules. Alternatively, the materials are not produced unless the receiving device has capacity similar to the NAS for regulating usage and copying.

e. the files can be deleted to save hard disk space if users don't want the backup anymore.

f. the files cannot be streamed or played outside of the home network 102 boundary so there is no peer-to-peer copy or streaming (enforced by NAS 112, perhaps with the assistance of the wireless gateway 106).

g. optionally, the software can register the ripping status into a central repository to disable user ripping the same content again in another network unless the first copy is deleted from the NAS. This will require internet connection to complete the transaction. For this embodiment, the NAS establishes a communication link with the central repository to obtain permission to produce the copy of the media or files.

With this solution, One Time Programmable (OTP) Secret/Public Keys and IDs may be employed for storage and playback operations. The NAS 112 will then have per-chip unique information “burnt-in” at time of manufacture with this information used thereafter for storage and playback. Further, an Integrated DES/3DES/AES core may be used for encrypted file storage. With this solution, hard disk drive (HDD) data cannot be read even if physically removed from the NAS 112. The Protected PVR content may operably be stored as encrypted files in proprietary format in the NAS 112 so that protected content can only be copied as encrypted backup, but cannot be copied out to CD-R or DVD-R as clear text for sharing.

In the storage of the content on the HDD of the NAS 112, an “Invisible Partition” may be employed. Using this technique, other unauthorized, non-DRM networks devices (e.g., PC) on the home network 112 cannot see the protected contents of the HDD of the NAS 112. The partition size employed on the HDD of the NAS 112 can be dynamically adjusted by the end-users based upon storage needs.

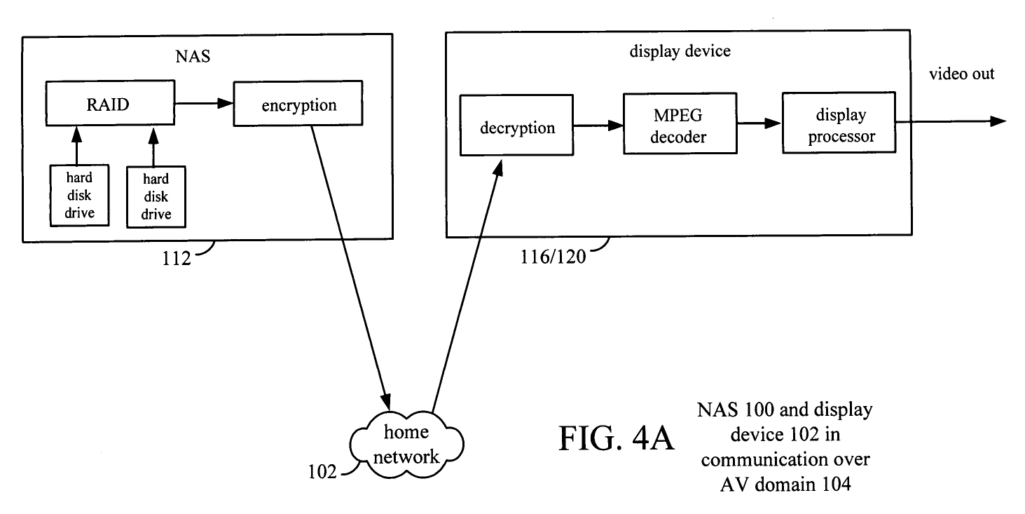

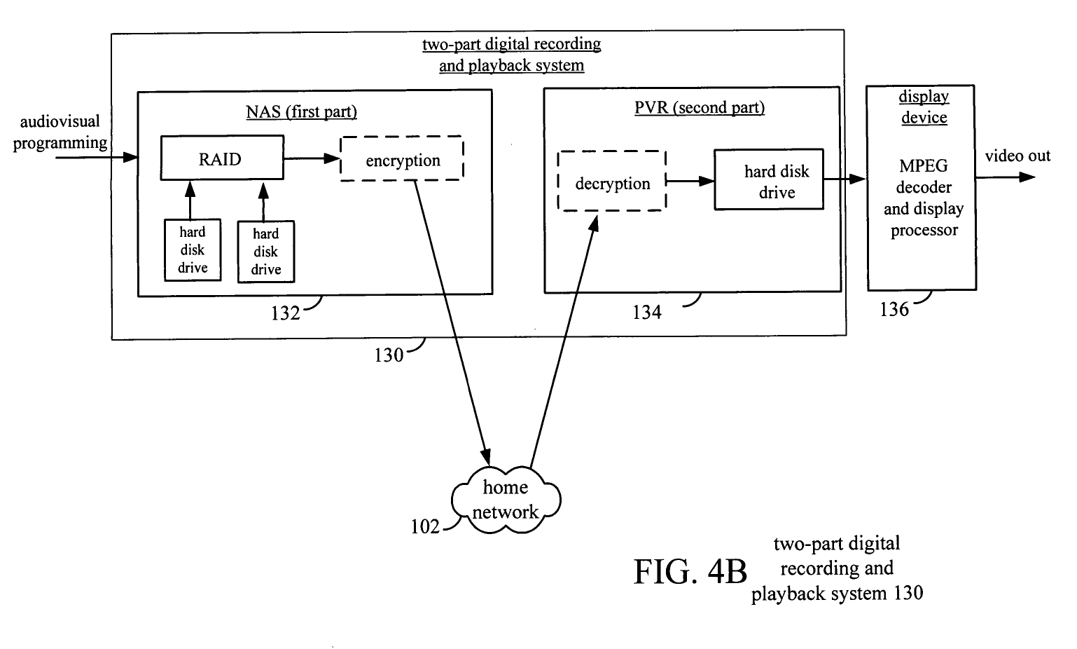

FIG. 4A is a block diagram illustrating a network attached storage (NAS) device constructed according to the present invention. As shown, the NAS 112 may include a RAID HDD configuration in which multiple HDDs are employed in a redundant fashion. As was described above with reference to FIG. 3, the HDDs may be partitioned. While FIG. 4A illustrates that NAS 112 and display device such as the STBs 116/120 communicate over a home network 102, FIG. 4A does not specifically represent that the home network is any particular type of network. Thus, home network 102 may comprise wireless components including access points and hosts in a wireless LAN configuration or, alternatively, a wired LAN, or a combination thereof. Thus, the NAS 112 may be wired to other devices including an access point for wireless transmissions or may be configured to directly transmit data and audiovisual programming over a wireless link. As will be described in greater detail below, NAS 112 of FIG. 4A is operable to produce audiovisual programming to display device 116/120 according to whether a valid PKI for device 116/120 is verified and according to the nature of display device 116/120 in relation to specified protection rights for the audiovisual programming. For example, for highest levels of specified copyright protection, NAS 112 may provide full quality audiovisual programming only to specified devices that have only a read capability that have controlled write capabilities (will not duplicate materials that are protected at specified levels of protection).

In a prior art system, the traditional PVR-STB receives an analog signal from its servicing network, e.g., cable network, satellite network, fixed wireless network, etc., decodes the signal, MPEG encodes the signal, encrypts the signal, and writes the encoded and encrypted data to a HDD of the PVR-STB. These operations comprise storage path operations. For playback path operations, the encoded and encrypted data is read from the HDD, decrypted, MPEG decoded, and processed to produce a signal compatible with a serviced TV/monitor.

With the operations of the present invention, at least one HDD is employed for storage of multimedia content. The HDD(s) is (are) located in the NAS 112 instead of the PVR-STB. Thus, the output of the MPEG encoder is transferred across the home network via the wireless gateway 106 to the NAS 112. The NAS 112 receives the data, encrypts the data for storage, and stores the device on a HDD. In one construction, the NAS 112 includes a redundant array of inexpensive disks (RAID) of hard disk drives for redundancy.

In a playback path, the RAID reads desired programming from the HDD array, optionally decrypts the data, and sends the data across the home network 102 to an STB or display device 116/120 for playback. The display device 116/120 receives the data from the home network 102, decrypts the data, if the NAS 112 did not previously decrypt the data, MPEG decodes the data, display processes the data, and provides a video out signal to a serviced TV or monitor. The receiving device may also be any other playback device, such as LCD playback device 124. As stated before, LCD playback device 124 may be an in-car LCD player with an associated PVR for wirelessly received audiovisual programming generated by NAS 112 or any other type of LCD playback device.

FIG. 4B is a functional block diagram of a two-part digital recording and playback system formed according to one embodiment of the invention. With application of the invention in an embodiment as shown in FIG. 3, it may be seen that audiovisual programming is received by a two-part digital recording and playback system 130 from an audiovisual programming source (satellite, cable, DVD, etc.), is stored in a digital recorder (NAS 132), is produced to a second digital recorder (PVR-STB 134) over a home network 102 and is ultimately played on a playback device (here, display device 136 that produces video out for display on a video monitor or screen). In a general sense, therefore, the present invention contemplates, in one embodiment, an at least two-part digital recording and playback system wherein a first part records and controls playback of audiovisual programming and wherein a second part records and subsequently produces the audiovisual programming to a display (including sound) system. The first part of the two-part digital recording and playback system operates according to what is described herein. While the first part is shown as a NAS, the first part is operable to include capabilities of the various embodiments of the invention and is therefore operable to achieve functionality that exceed prior art PVRs, though it may be considered to be a PVR with enhanced security aspects. Thus, the invention, in one embodiment, contemplates a pair of sequentially coupled PVR devices as a two-part digital recording and playback system operable to produce controlled playback of audiovisual programming to protect against unauthorized copying of protected audiovisual programming. In the specific embodiment, a home network is shown between the first and second parts. It is understood, of course, that a direct wired connection may couple the first and second parts directly or, alternatively, that a wireless connection may couple the first and second parts. One aspect to observe of the embodiment of FIG. 4B is that a plurality of HDDs are utilized in a sequential manner as a part of storing audiovisual programming for playback wherein a first portion is operable to control playback and does not directly couple to a display device. Rather, a second PVR is coupled between the first PVR (in the form of a NAS) and a playback device.

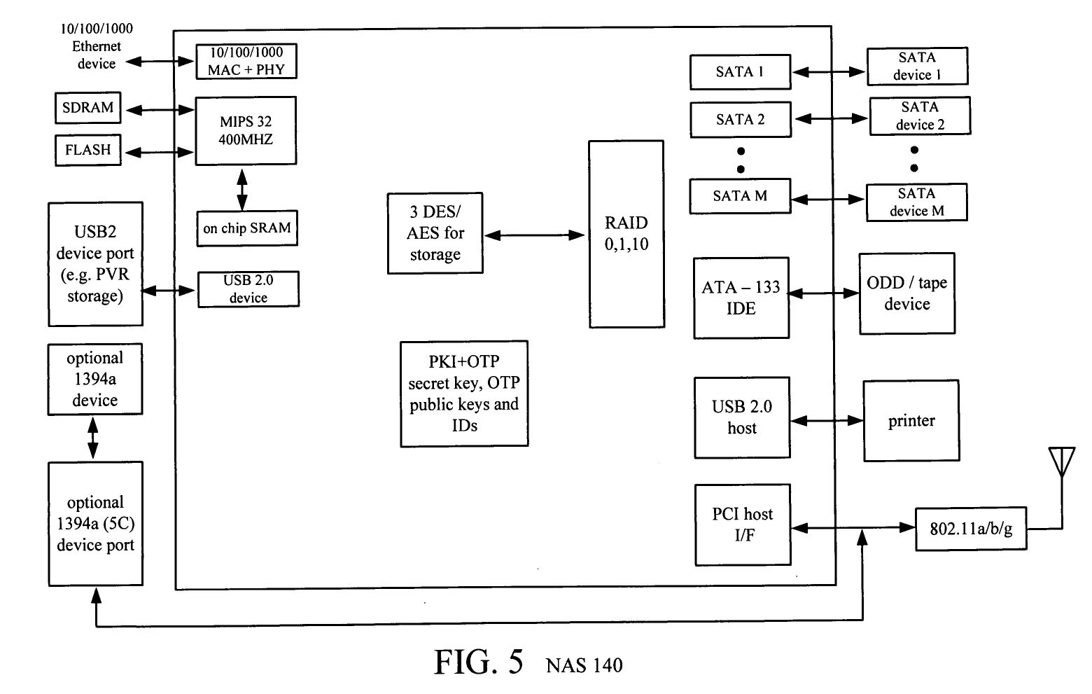

FIG. 5 is a block diagram illustrating the structure of a NAS constructed according to the present invention. NAS 140 of FIG. 5 includes “M” Serial ATA (Advanced Technology Architecture) interface device ports for coupling to external SATA (Serial ATA) devices. SATA is a new interface that is designed to overcome the limitations of parallel ATA and that may eventually replace it because it provides scalability, performance, flexibility, and cost efficiency relative to parallel ATA devices. Generally, Serial ATA is a drop-in solution which will run on the new architecture without modification. Nonetheless, NAS 140 also includes an IDE ATA 133 port for coupling to an ODD (Optical Disk Drive) or tape device.

NAS 140 further includes a plurality of universal serial bus (USB) ports for coupling the NAS 140 to external devices such as PVR storage devices, printers and other multi-function machines. In addition to the USB and SATA ports, NAS 140 further includes a peripheral component interconnect (PCI) bus for coupling to anyone of a plurality of device types. In the described embodiment, NAS 140 includes a PCI interface for coupling to a radio transceiver for operation as a host device. More specifically, the PCI interface is coupled to an IEEE 802.11-standard radio transceiver. The described embodiment of the invention includes at least one Ethernet port for coupling to an Ethernet device. In the described embodiment, the Ethernet port is for coupling and communicating with 10/100/1000 Mb/s Ethernet LANs. Finally, NAS 140 includes one or more, according to various embodiments of the invention, interface ports for coupling internal processor(s) to on board and external memory including synchronous dynamic random access memory (SDRAM) and Flash memory.

In the described embodiment, the PCI bus is optionally coupled to a firewire port which is also known as an IEEE 1394a port. Applications that operate according to IEEE 1394a include nonlinear (digital) video presentation and editing, desktop and commercial publishing, document imaging, home multimedia, and personal computing. IEEE 1394a provides for low overhead, high data rates, as well as the ability to mix real-time and asynchronous data on a single connection, and the ability to mix low speed and high speed devices on the same network, provide a good bus for consumer, computer, or peripheral application. 1394a is a peer-to-peer serial bus with speeds up to 393.216 Mbits/s.

In addition to the above described ports for communicating with external devices, NAS 140 includes data storage (shown in FIG. 5 as RAID 0, 1, 10) coupled with an encryption block (shown in FIG. 5 as 3DES/AES) for encrypting stored data. Data Encryption Standard (DES) is a popular symmetric-key encryption algorithm that uses a 56-bit key and a block cipher method for encrypting which breaks data into 64-bit blocks prior to encryption. The Advanced Encryption Standard (AES) is a symmetric 128-bit block data encryption technique that may be used in place of DES. While one embodiment of the invention includes DES/AES encryption for data storage, another embodiment further protects data by storing the data in a non-standard partition and storage protocol to prevent easy access by known devices. Each of these techniques are utilized to safeguard data stored within or controlled by NAS 140.

In addition to protecting such data, however, data delivery also requires protection. Thus, the above mentioned encryption techniques may further be used to encrypt outgoing data produced on any one of the above referenced ports in the above referenced data port interface types. In addition to providing protection for transmitted data, however, protecting audiovisual programming, for example, may include protecting against unauthorized copying of data by a remote receiver. Accordingly, known validation protection schemes including one time password (OTP) and public-key infrastructure (PKI) may be utilized. Generally, PKI is a combination of software, encryption technologies, and services that protect the security of communications and business transactions on the Internet. More specifically, PKIs integrate digital certificates, public-key cryptography, and certificate authorities into a total, enterprise-wide network security architecture. A typical enterprise's PKI encompasses the issuance of digital certificates to individual users and servers; end-user enrollment software; integration with corporate certificate directories; tools for managing, renewing, and revoking certificates; and related services and support. PKI protects information with digital certificates by authenticating identity, verifying integrity of data by verifying the data has not been modified in transit, providing privacy to protect from interception, and providing authorized access by replacing easily guessed and frequently lost user IDs and passwords to streamline intranet log-in security.

In light of the present invention, the PKI certificates are used along with an evaluation of the device type as a part of determining whether audiovisual programming may be provided to an end device.

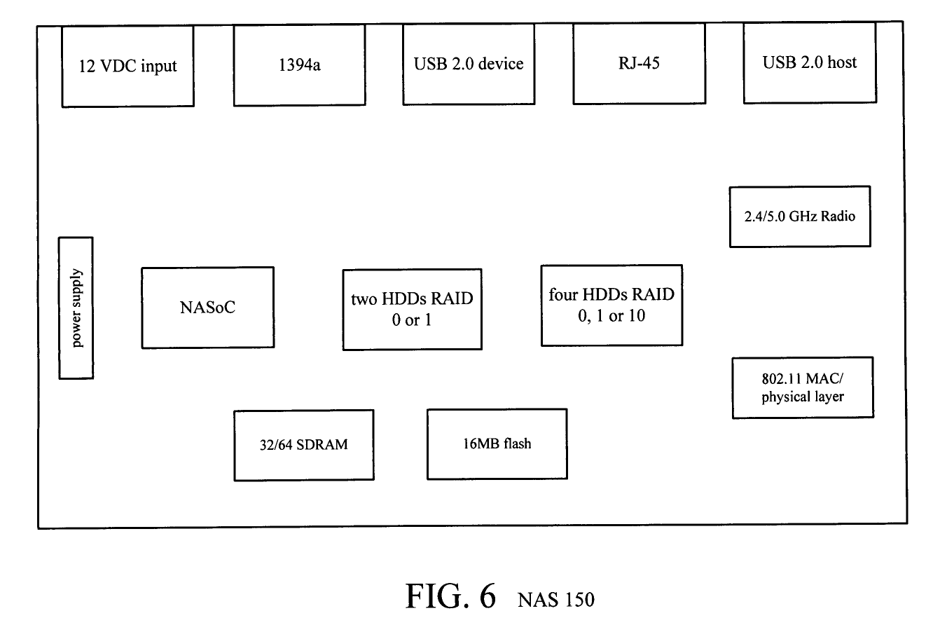

FIG. 6 is a functional block diagram of a NAS formed according to one embodiment of the invention. More specifically, FIG. 6 illustrates one embodiment of a NAS on a chip (NASoC). As with the embodiment of FIG. 5, NAS 150 of FIG. 6 includes a plurality of RAID hard disk drives, a radio, USB ports, a power supply, an RJ-45 port, and a 12 VDC input. In the specific embodiment of NAS 150, two RAID 0 or RAID 1 hard disk drives are provided, and for RAID 0, 1, or 10, hard disk drives are provided for storing data and audiovisual programming. The radio of NAS 150 may comprise either a 2.4 GHz 802.11b radio or a 5.0 GHz 802.11a-g radio. While not specifically shown in FIG. 6, NAS 150 further includes operating logic to operate as described herein and specifically includes OTP and PKI processing logic for encrypting and protecting data.

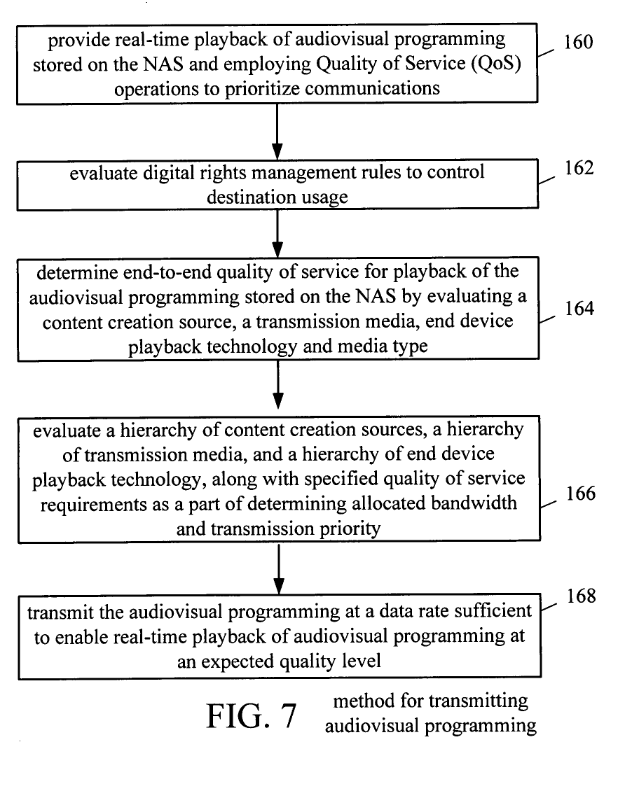

FIG. 7 is a flowchart illustrating a method for transmitting audiovisual programming according to one embodiment of the present invention. Generally, the method of FIG. 7 is for producing audiovisual programming in a digital media format to a remote playback device in a content and transmission media aware network attached storage device for servicing communications through a gateway to an end device in the network for content stored in the network attached storage device. The method includes initially providing real-time playback of audiovisual programming stored on the NAS and employing quality of service (QoS) operations to prioritize communications (step 160). As described herein, specified types of data, including audiovisual programming, require higher levels of bandwidth and priority to provide a desired quality of service. Accordingly, assigning appropriate priorities is often referenced as employing quality of service scheduling or operations to prioritize the communications. In addition, the method performed by the NAS includes evaluating digital rights management rules to control destination usage (step 162). Evaluating digital rights management rules includes, in the described embodiment of the invention, not only evaluating whether correct PKI-OTP codes correspond with a receiving end device, but also evaluating the type of end device and whether such end device has the ability to make copies of copy-restricted information, including audiovisual programming. For example, if the end device is merely a playback device with no capability for reproducing the data, then digital rights management rules may readily provide for allowing the NAS to provide the audiovisual programming for playback. On the other hand, if the end device has the capacity to make an unauthorized copy of the restricted information, then the digital rights management rules may require evaluating whether the end device includes logic for restricting such copying of protected information.

The method according to the present invention also includes determining end-to-end quality of service for playback of the audiovisual programming stored on the NAS by evaluating a content creation source, a transmission media, end device playback technology, and media type (step 164). The method further includes evaluating a hierarchy of content creation sources, a hierarchy of transmission media, and a hierarchy of end device playback technology, along with specified quality of service requirements as a part of determining allocated bandwidth and transmission priority (step 166). Generally, steps 164 and 166 relate to the NAS efficiently producing audiovisual programming by determining and evaluating content quality, audio and visual reproduction quality, including video resolution in the end device, and finally, an amount of expected interference or signal quality in the transmit path of the audiovisual programming. Finally, the invention of FIG. 7 includes transmitting the audiovisual programming at a data rate sufficient to enable real-time playback of audiovisual programming at an expected quality level (step 168).

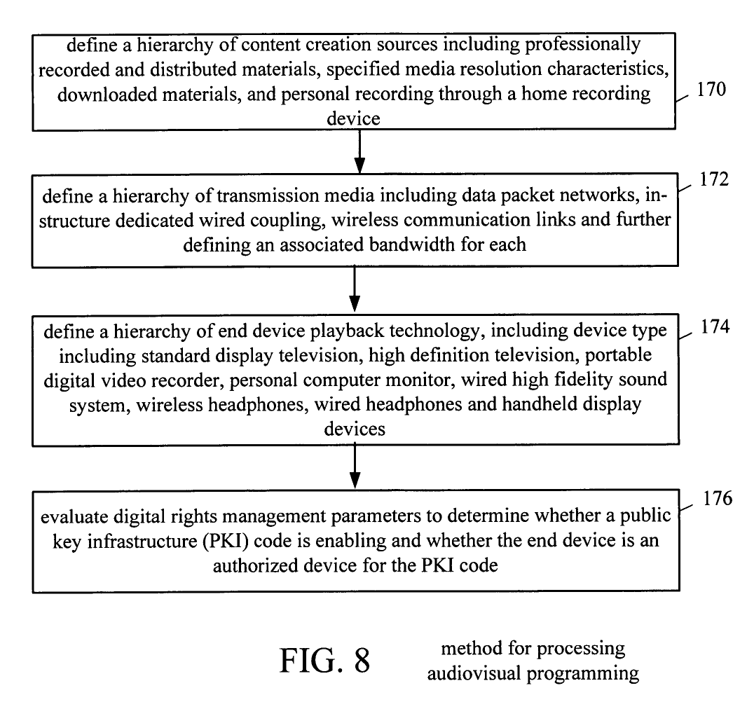

FIG. 8 is a flowchart illustrating a method for processing audiovisual programming according to one embodiment of the present invention. The invention includes initially defining a hierarchy of content creation sources, including professionally recorded and distributed materials, specified media resolution characteristics, downloaded materials, and personal recording through a home recording device (step 170). One assumption that relates to the hierarchy of content creation sources is that some content creation sources produce higher resolution and quality materials than others, thereby justifying increased quality of service provisioning and guarantees. For example, professionally recorded and distributed materials are almost certain to have higher quality recordings, meaning lower noise and higher sample rates and resolution, than personal recording devices. Thus, the invention contemplates giving priority according to an assumed quality of a particular content.

The embodiment of the invention further includes defining a hierarchy of transmission media, including data packet networks, in-structure dedicated wired coupling, wireless communication links, and further defining an associated bandwidth for each (step 172). A hierarchy of transmission media is defined under the assumption that some transmission media types have higher capacity levels and have lower interference levels for transmission of audiovisual programming or other digital data. Next, the method includes defining a hierarchy of end device playback technology, including device type, wherein the device type includes, for exemplary purposes, standard display televisions, high definition televisions, portable digital video recorders, personal computer monitors, wired high fidelity sound systems, wireless headphones, wired headphones, and handheld display devices (step 174). Generally, the hierarchy of end device playback technology is generated so as to avoid the transmission of data having higher quality or resolution levels than can possibly be appreciated by a user of the end device having specified quality playback characteristics.

Finally, the embodiments of the invention include evaluating digital rights management parameters to determine whether a public key infrastructure (PKI) code is enabling and whether the end device is an authorized device for the PKI code (step 176). As discussed herein, the NAS not only evaluates whether a correct PKI code has been associated with the end device, but whether the end device is authorized to receive the audiovisual programming. This specific analysis includes considerations such as whether the end device has the unrestricted ability to make copies of the audiovisual programming or digital data.

The embodiments of the invention disclosed herein are susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents and alternatives falling within the spirit and scope of the present invention as defined by the claims.

1. A system for wireless and wired servicing of audiovisual and data networking communications, the system comprising:
a network gateway that services communications within a network;
at least one user playback end device communicatively coupled to the network gateway;
a content and transmission media aware network attached storage device (NAS); and
wherein the NAS services communications through the gateway to the at least one user playback end device in the network from content stored in the NAS at a data rate sufficient to enable real-time playback of audiovisual programming at an expected quality level.

2. The system of claim 1, wherein the NAS read-protects audiovisual information that it stores.

3. The system of claim 1, wherein in servicing communications between the gateway and the NAS at a data rate sufficient to enable real-time playback of audiovisual programming stored on the NAS, wherein the NAS employs classification of service operations to prioritize communications according to file type and evaluates, among other types whether the file is a PVR file, an MPG file, an AVI file, a WMV file, an MP3 file, a WMA file, an AAC file, or a bulk data file.

4. The system of claim 3, wherein in servicing communications between the gateway and the NAS at a data rate sufficient to enable real-time playback of audiovisual programming stored on the NAS, the gateway employs bandwidth allocation operations based upon the classification of service to provide sufficient data throughput for the communications.

5. The system of claim 1 wherein the NAS determines end-to-end quality of service for playback of the audiovisual programming stored on the NAS by evaluating a content creation source, a transmission media, end device playback technology and media type.

6. The system of claim 5 wherein the NAS defines a hierarchy of content creation sources including professionally recorded and distributed materials, specified media resolution characteristics, downloaded materials, and personal recording through a home recording device.

7. The system of claim 5 wherein the NAS defines a hierarchy of transmission media including data packet networks, in-structure dedicated wired coupling, wireless communication links and further defines an associated bandwidth for each.

8. The system of claim 5 wherein the NAS defines a hierarchy of end device playback technology including device type including standard display television, high definition television, portable digital video recorder, personal computer monitor, wired high fidelity sound system, wireless headphones, wired headphones and handheld display devices.

9. The system of claim 8 wherein the hierarchy of end device playback technology further includes associated display resolution parameters.

10. The system of claim 1 wherein the NAS evaluates digital rights management parameters to evaluate whether a public key infrastructure (PKI) code is enabling and whether the end device is an authorized device for the PKI code.

11. The system of claim 1 wherein the NAS evaluates a hierarchy of content creation sources, a hierarchy of transmission media, and a hierarchy of end device playback technology along with specified quality of service requirements as a part of determining allocated bandwidth and transmission priority.

12. A content and transmission media aware network attached storage device (NAS) system for servicing communications through the gateway to the end device in the network from content stored in the NAS at a data rate sufficient to enable real-time playback of audiovisual programming at an expected quality level, the NAS comprising:
a two-part digital recording and playback system further including:
a first part for storing audiovisual programming in a proprietary and non-standard digital media format to preclude the digital media being played by known technology without authorization by the NAS; and
a second part to enable real-time playback of audiovisual programming stored on the NAS, wherein the NAS employs Quality of Service (QoS) operations to prioritize communications;
wherein the first part of the NAS system determines end-to-end quality of service for playback of the audiovisual programming stored on the NAS by evaluating a content creation source, a transmission media, end device playback technology and media type;
wherein the first part of the NAS evaluates a hierarchy of content creation sources, a hierarchy of transmission media, and a hierarchy of end device playback technology along with specified quality of service requirements as a part of determining allocated bandwidth and transmission priority, and
wherein the second part of the NAS system stores received audiovisual programming for playback on a playback device.

13. The content and transmission media aware NAS system of claim 12 wherein the NAS system defines the hierarchy of content creation sources including professionally recorded and distributed materials, specified media resolution characteristics, downloaded materials, and personal recording through a home recording device.

14. The content and transmission media aware NAS system of claim 13 wherein the first part defines the hierarchy of transmission media including data packet networks, in-structure dedicated wired coupling, wireless communication links and further defines an associated bandwidth for each.

15. The content and transmission media aware NAS system of claim 14 wherein the first part defines the hierarchy of end device playback technology including device type including standard display television, high definition television, portable digital video recorder, personal computer monitor, wired high fidelity sound system, wireless headphones, wired headphones and handheld display devices.

16. The content and transmission media aware NAS system of claim 15 wherein the hierarchy of end device playback technology further includes associated display resolution parameters.

17. The content and transmission media aware NAS system of claim 13 wherein the NAS evaluates digital rights management parameters to evaluate whether a public key infrastructure (PKI) code is enabling and whether the end device is an authorized device for the PKI code.

18. The content and transmission media aware NAS system of claim 13 wherein the NAS utilizes a proprietary formatting system to preclude reading of the stored materials by other devices.

19. The content and transmission media aware NAS system of claim 13 wherein the NAS evaluates previous playback to prevent the same file from be played by more than one device at any time including the NAS only producing to one device at a time.

20. The content and transmission media aware NAS system of claim 13 wherein the NAS is operable to produce a subsequent copy to any playback device only after determining that a previously produced copy has been, removed, deleted, or destroyed.

21. The content and transmission media aware NAS system of claim 13 wherein the NAS is operable delete a file copy in conjunction with producing the file to another device if the other device has file storage capacity.

22. The content and transmission media aware NAS system of claim 13 wherein the NAS is operable produce the media or files to another device having recording capacity only if the receiving device also has capacity to regulate usage that at least comports with known digital rights management rules.

23. The content and transmission media aware NAS system of claim 13 wherein the NAS is operable to only produce files to a receiving device having capacity similar to the NAS for regulating usage and copying.

24. The content and transmission media aware NAS system of claim 13 wherein the NAS is operable prevent files from being streamed or played outside of a home network boundary.

25. The content and transmission media aware NAS system of claim 13 wherein the NAS is operable register the ripping or copying status into a central repository to disable user ripping the same content again in another network unless the first copy is deleted from the NAS.

26. A method for producing audiovisual programming in a digital media format to a remote playback device in a content and transmission media aware network attached storage device (NAS) for servicing communications through a gateway to an end device in the network from content stored in the NAS, comprising:
providing real time playback of audiovisual programming stored on the NAS and employing Quality of Service (QoS) operations to prioritize communications;
determining end-to-end quality of service for playback of the audiovisual programming stored on the NAS by evaluating a content creation source, a transmission media, end device playback technology and media type;
evaluating a hierarchy of content creation sources, a hierarchy of transmission media, and a hierarchy of end device playback technology along with specified quality of service requirements as a part of determining allocated bandwidth and transmission priority; and
transmitting the audiovisual programming at a data rate sufficient to enable real-time playback of audiovisual programming at an expected quality level.

27. The method of claim 26 further including defining the hierarchy of content creation sources including professionally recorded and distributed materials, specified media r resolution characteristics, downloaded materials, and personal recording through a home recording device.

28. The method of claim 27 further including defining the hierarchy of transmission media including data packet networks, in-structure dedicated wired coupling, wireless communication links and further defining an associated bandwidth for each.

29. The method of claim 28 further including defining the hierarchy of end device playback technology including device type including standard display television, high definition television, portable digital video recorder, personal computer monitor, wired high fidelity sound system, wireless headphones, wired headphones and handheld display devices.

30. The method of claim 29 wherein the hierarchy of end device playback technology further includes associated display resolution parameters.

31. The method of claim 26 further including evaluating digital rights management parameters to determine whether a public key infrastructure (PKI) code is enabling and whether the end device is an authorized device for the PKI code.

32. The method of claim 28 wherein the transmission media includes a home based cable network and wherein the method includes transmitting the audiovisual programming over the home based cable network.

33. The method of claim 28 wherein the transmission media includes at least one of a Bluetooth wireless network and an IEEE 802.11 standard protocol wireless network and wherein the method includes transmitting the audiovisual programming over one of the Bluetooth and 802.11 standard protocol wireless networks.

34. The method of claim 28 further including storing the audiovisual programming in a proprietary and non-standard format to preclude unauthorized access wherein the proprietary and non-standard format is not decipherable by known devices that read digital media.

35. The method of claim 34 further including, as a part of producing audiovisual programming in a digital media format, reconstructing the audiovisual programming into a non-proprietary and standard format.

36. The method of claim 26 further including providing port based bandwidth priority wherein a device producing digital media on a first port is given priority over a device producing digital media on a second port.

37. The method of claim 26 further including evaluating digital rights management rules to control destination usage including a PKI code for the remote playback device and further evaluating capability of the end user device.

38. The method of claim 37 wherein the NAS only produces audiovisual programming having copy restrictions to a PKI enabled device that does not have copying capability for making permanent copies of the audiovisual programming.

39. The method of claim 37 wherein the NAS evaluates safety of a transmission link and, based upon the evaluated safety of the transmission link, provides a specified amount of protection for audiovisual programming which is to be propagated over the transmission link.
